(19) United States
(12) Patent Application Publication
(10) Pub. No.: US 2004/0230892 A1
(43) Pub. Date: Nov. 18, 2004

(54) Systems and methods for document project management

(75) Inventor: D. Troy Horton, Sandy, UT (US)

Correspondence Address: Kory D. Christensen, STOEL RIVES LLP, One Utah Center, 201 South Main Street, Suite 1100, Salt Lake City, UT, 84111, US

(73) Assignee: LIBAC Corporation, Salt Lake City, UT

(21) Appl. No.: 10/802,258

(22) Filed: Mar. 17, 2004

Related U.S. Application Data
(60) Provisional application No. 60/455,148, filed on Mar. 17, 2003.

(51) Int. Cl. G06F 15/00; G06F 17/00

(52) U.S. Cl. 715/511

(57) ABSTRACT

A document project management system includes means for receiving a plurality of proposed revisions to an original portion of a document; means for displaying the original portion of the document; means for displaying with the original portion each of the plurality of proposed revisions; means for highlighting differences with the original portion in each of the plurality of proposed revisions; and means for allowing a reviewer to either select one of the proposed revisions or cut and paste text from one or more of the revisions to replace the original portion.

### Cross-Reference to Related Applications

This application claims the benefit of U.S. Provisional Application No. 60/455,148, filed Mar. 17, 2003, with inventor D. Troy Horton, which application is incorporated herein by reference in its entirety.

### TECHNICAL FIELD

The present invention relates generally to document preparation. More specifically, the present invention relates to systems and methods for document project management.

### BACKGROUND OF THE INVENTION

During large document drafting and preparation projects, the document project manager typically assigns document sections and sub-sections to document team members. These team members draft and revise document sections. For each document section there is typically more than one person proposing document drafts and revisions. The tools currently available for online document preparation do not support the simultaneous viewing of proposed drafts and revisions from multiple sources.

Another problem with document management is that each person working on a document preparation team makes multiple drafts which get combined into multiple versions. Tracking the multiple drafts and versions that come from different team members requires significant time and attention.

Yet another problem is found when using typical online tools for document management. Document preparation team members must manually post document drafts and revisions into a central document repository. This approach does not adequately enable team-level security (for example, during a merger and acquisition document project, it is sometimes desirable for separate teams to not view each others' documents) or local storage of documents.

### BRIEF DESCRIPTION OF THE DRAWINGS

FIG. 1 is an example user interface for simultaneous viewing of proposed document drafts and revisions from multiple reviewers and sources;

FIG. 2 is a block diagram of a document project management system;

FIG. 3 is a block diagram of a document collaboration and management system; and

FIG. 4 is a workflow diagram according to an embodiment of the invention.

### DETAILED DESCRIPTION

In the following description, numerous specific details of programming, software modules, user selections, network transactions, database queries, database structures, etc., are provided for a thorough understanding of the embodiments of the invention. However, those skilled in the art will recognize that the invention can be practiced without one or more of the specific details, or with other methods, components, materials, etc.

In some cases, well-known structures, materials, or operations are not shown or described in detail in order to avoid obscuring aspects of the invention. Furthermore, the described features, structures, or characteristics may be combined in any suitable manner in one or more embodiments.

Simultaneous View and Select

As noted above, the tools available for online document preparation do not support the simultaneous viewing of proposed drafts and revisions from multiple sources.

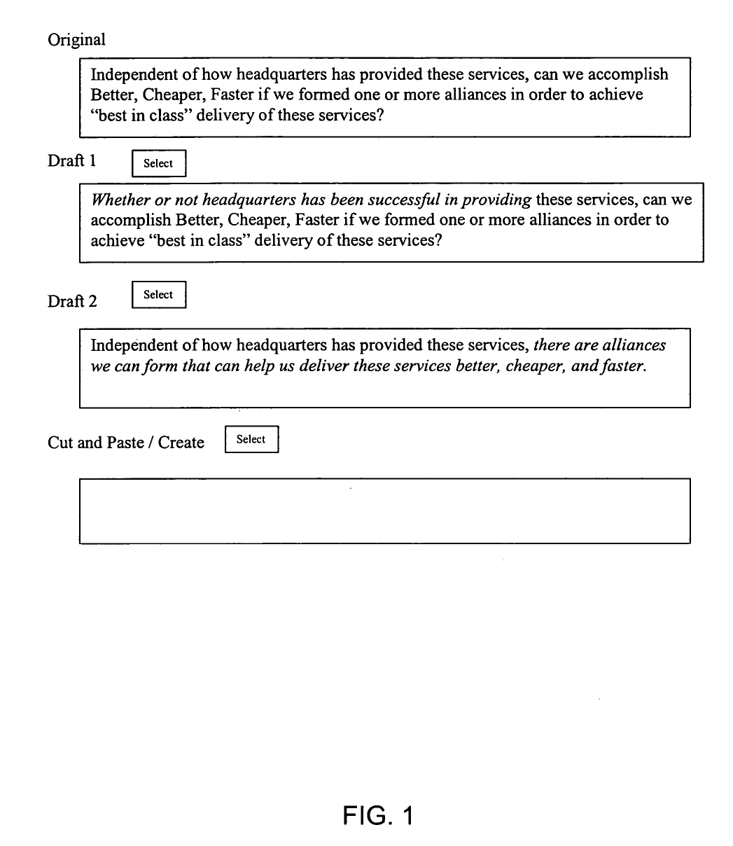

FIG. 1 illustrates an example user interface for simultaneous viewing of proposed document drafts and revisions from multiple reviewers and sources. Using this functionality, a document team member can perform a simultaneous, side-by-side comparison of the differences being suggested by multiple drafters of a document section.

In one embodiment, the differences are highlighted in order to make it easy to find differences. Each separate proposed draft or revision is segmented so that the document team member can select one of the proposed drafts or revisions. The team member can also cut and paste segments from more than one draft or revision into the final version. Finally, the team member can also create his or her own version.

Local and Global Drafting and Versioning

As explained above, another problem with document management is that each person working on a document preparation team makes multiple drafts which get combined into multiple versions.

In one embodiment, the LIBAC system gives both a draft number and version number. For example, person A's multiple drafts are tracked by that person's draft numbering system. Person A then selects which draft will be submitted for inclusion in the document.

When the document project manager or document owner selects which drafts to include in the next version of the document, the system assigns a new version number to the document. Using this system, pervious drafts and versions are easily accessible and the document is built without confusion or rework.

Multi-tiered Document Repository

As described above, conventional approaches do not adequately enable team-level security, for example, during a merger and acquisition document project.

According to one embodiment of the invention, the LIBAC system provides the following tiers of document repositories:

Tier 0-Global document repository. Holds generalized and public available documents and templates. LIBAC customers use documents in this repository as a starting source by customizing the generalized documents.

Tier 1-Customer document repository. Holds documents for a specific LIBAC customer. This repository contains both active and archived documents. Licensed employees of the LIBAC customer can access this repository.

Tier 2-Project document repository. Holds the documents, drafts, revisions, project communications, and project plans for an active document project. Named project team can access documents in this repository.

Tier 3-Sub-project document repositories. Identical to project document repositories but accessible only to specified sub-project team members. Returning to the merger and acquisition example above: The document project manager can create sub-project teams that can access their Tier 2 repository but cannot access each others' Tier 3 repositories. Using this functionality, the documents of the acquiring party are separate from the documents of the acquired party.

Architecture

In one implementation, the LIBAC technology is J2EE standards based, object-oriented, and uses an integration layer that utilizes Java messaging. All application modules are built on and around a J2EE and JMS (or Web Services) integration layer. The ability of applications to connect to and inter-operate with this integration layer is a critical application selection criterion.

Architecturally, the LIBAC technology may operate in a secure, multiple-instance mode with multiple customers using their own secure, separate instance of the applications. Additionally, each customer may also create multiple instances of the applications to support multiple teams.

The multiple-instance environment includes:

LIBAC (Tier 0) instances to support the LIBAC data and global repository.

LIBAC (Tier 1) customer instances. This includes both licensed LIBAC customers and project usage customers. These customers will create corporate/organizational instances.

Project (Tier 2 and Tier 3) instances. This includes instances for project teams (Tier 2) and sub-project teams (Tier 3).

LIBAC customers need only a client-side word processing application and Internet browser. These customers access the LIBAC system via the Internet or corporate Intranet and do not need to download a client application (beyond what is necessary to satisfy security requirements) in order to use the LIBAC application. However, if a customer needs to work on a project when not connected to the Internet, the customer may need to download and use a client-side application.

LIBAC customers can use the LIBAC system in two modes. In one mode, LIBAC hosts its system for customers that want to use the system on a project-by-project basis (ASP Solution). For these customers, LIBAC manages and stores project data in real time. In another mode, LIBAC installs its system in the production environment of its customers. For these customers, LIBAC performs a weekly backup of project data (Enterprise Solution).

Functional Overview

LIBAC customers use the LIBAC technology to manage the creation, review, editing, completion, filing, production, and distribution of financial and other documents. The LIBAC technology enables all of these separate processes to be conducted on-line or enables a downloadable version of the document to be checked out so the WGM can work off-line from their own laptop if unable to access the internet for a period of time and check back in the document upon return to internet access. This is critical as the current method for document preparation requires significant disruption for the separate groups involved in the creation of financial and other documents.

Document Management

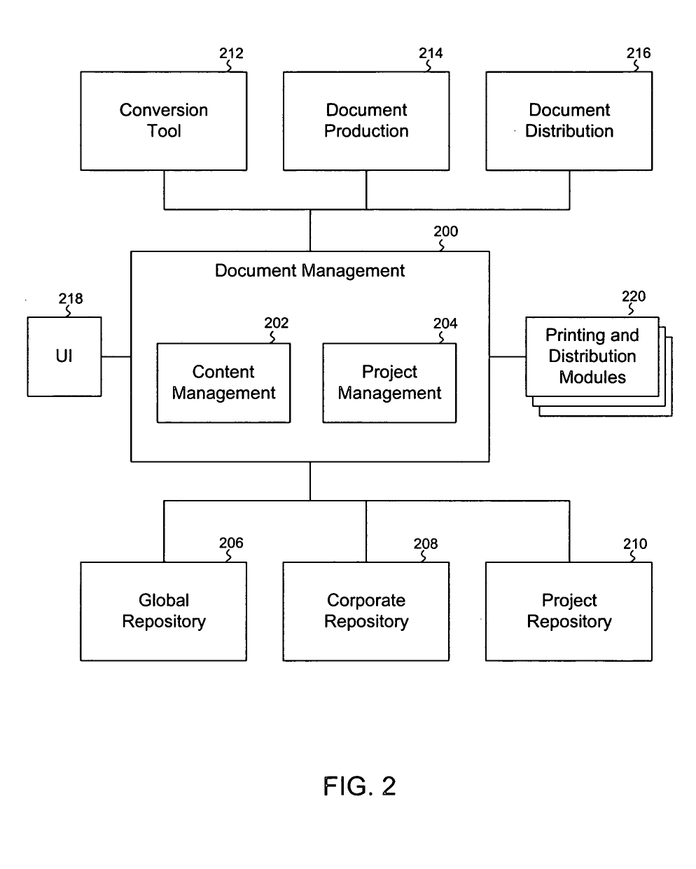

Referring to FIG. 2, a Document Management module 200 may include two major functionality subsections. The first, Content Management 202, includes the following functions:

Ability to find a source/initial document from a document repository and convert it into a specific (XML), custom document template. This requirement could utilize the LIBAC document conversion tools.

Ability to draft, review, edit, proofread, store, and retrieve documents.

Ability to apply notation to a given section being modified by a specific Working Group Member (WGM) which enables the editor to post comments to defend why his changes should be incorporated and not modified by up-line reviewers. These notes will be seen only during the drafting process for creation history purposes and will not be incorporated into the Final Typeset or Final EDGAR document which respectively will be printed or filed with the Securities Exchange Commission (SEC).

A flexible, configurable workflow engine with which authorized LIBAC users can define and manage review procedures and responsibilities. For example, a project manager (or authorized assistant) can configure the WGM workflow so that a draft being worked on by a given team member can be reviewed by a team leader before the system notifies the up-line manager (another team leader or the project manager) to review and approve, modify or reject edits before the final draft's cycle changes are applied to the core document and document version updated. Or, the workflow can be configured so that drafts are automatically included in a document version then reviewed by up-line team leaders or project manager.

The second major subsection of the Document Management module 200 is Project Management 204. Specific functionality of Project Management 204 includes:

The ability to create and administer project teams.

The ability to assign project tasks and timelines and track tasks and responsibilities.

Project accounting so that professional firms can track, compile, and report billing information.

The ability to generate task and project completion reports and alerts.

The ability to track the number of pages converted from original document to LIBAC System Typeset and or EDGAR final document(s) for Client billing purposes (this is the number of base document pages not the total number of pages including all revision pages)

The ability to communicate, at a minimum via email or chat rooms, with limited WGM's within a team or by all WGM's assigned to work on a given project. The LIBAC product roadmap includes communication using instant messaging and web conferencing.

The ability to create sub-working teams with their own secure document repositories.

In the Content Management 202 subsection, LIBAC may require unique functionality for document drafting, review, editing, proofreading, storage, and retrieval. Such requirements may include:

The ability for a project manager to divide a document into subsections that can be worked on separately and independently from the main document by project team members.

A document compare and review feature that:

Allows reviewers (team leaders or project manager) to simultaneously view drafts submitted by assigned WGM's.

Finds and highlights the differences among and between drafts submitted by different WGM's.

Allows reviewers to select (without cutting and pasting) a draft to include in the next document version, revise and select a draft, or to create their own draft.

An example process is described below:

Client signs up to become LIBAC user of the system.

LIBAC administrator generates client profile and the system generates and sends an email to the Client welcoming them as the newest member of the LIBAC solutions for real time document drafting, collaboration, printing, filing and distribution work issuing his/her “username” (email address retrieved from profile) and a “passcode” (random 6 digit alpha numeric code initially assigned) and invites the client (by name retrieved from client profile) to go to LIBAC's website (www.libac.com) and begin a project.

Client user (project lead or his/her assistant) logs onto the internet and enters the pre-assigned username and passcode at the home page of LIBAC.

At initial login the system gives user a chance to change LIBAC supplied passcode to their own confidential code which will be used from that point forward when they log into the system.

Upon login the client user sees all projects he/she has previously been assigned to that are currently live or can open a new project by clicking on “Client/Project Setup” in the upper left hand corner of the screen

If client user opens a new project they would fill in appropriate fields (see project set up screen on proof of concept demo) and attach the document(s) to be converted.

Client would then assign WGM's (by filing out profiles for each WGM if they are new or by using drop down menu to choose from an existing WGM list previously entered) to the project and issue rights for this given project after which the system would generate and send an email to each WGM notifying them there is a new project for them to work on.

If user opens an existing project they were previously assigned to, they can begin working on the project document by clicking on the document icon or project title.

Each member of the working group is assigned their own copy of the initial document(s) related to this project (held in the holding tank) uploaded by the project lead or authorized assistant (held in the central repository) and notified by a system generated email that version 1, draft cycle 00 is ready for their review.

The system enables WGM to edit within the web browser and/or allows WGM to checkout a document, make edits on their computer in the word processor or spreadsheet (for financials) of their choice and enables WGM to later check in the document version from which the system would update a new draft cycle number (from 00 to 01 etc.).

The system identifies differences between the versions created by WGM. These differences could include different words or punctuation in a sentence, added or deleted sentences in a paragraph, new or deleted paragraphs in a section, new or deleted sections.

The system provides the WG team leader or document owner (project lead or authorized assistant) a view of each different version by sentence, paragraph, or section. Each difference is presented sequentially by document section.

This view allows the WG team leader or document owner to select one of the versions or to create (using normal word processing tools such as new entry, cut, copy, and paste) a new version.

The selected or created version is saved as either a new draft within a version (“Save as Draft” command, which maintains the current version number and updates the draft number by one number larger i.e. 00 to 01, 02 ...) or saved as a new version (“Save as Final” command which updates version by one number i.e. 01 to 02, 03... etc. and returns draft cycle numbers to 00) and is saved back into the document repository.

The system retains all original and subsequent versions and draft cycles so that the WG lead can, if needed, re-do the document review operation with other document versions and or draft cycles (interim version updates).

Additional features of the system may include:

The ability to merge the selected or revised drafts into the next document version.

A two-tiered versioning system that: 1) updates the draft number of a draft when it is saved or posted back into the document repository and 2) updates the version number of a document when it is merged and saved back into the document repository.

A document repository that is accessed via the Internet or Intranet. The repository maintains a record of what documents and subsections are checked out to which team members. The repository contains current and previous document drafts and versions.

Full text search of documents in the repository.

Document translators that convert documents from major word processing applications (Word, WordPerfect, Lotus Notes, Excel, HTML) into and from a standard, XML-based format. These translators allow LIBAC customers to use their various, existing word processing tools while maintaining document formats, style guides, and templates.

Typical Process

For Content Management 202, the typical process for document creation and completion is:

Project manager searches the global or corporate intranet document repository for a source document. (These document repositories are described in the section below).

Project manager configures the project workflow and the project document repository.

Project manager makes the entire document available or divides the document into subsections and assigns draft and revision tasks to team members.

Team members check-out documents or subsections and create drafts.

Team members check-in final drafts.

Reviewers view multiple drafts for a given document or subsection and accept, reject or modify changes to create the final draft master.

The project manager updates the final draft master changes into the core master. This creates a new document version. The system automatically notifies working group members via e-mail that a new version exists and is ready for their review.

The process repeats until a final core master version is achieved.

Document Repositories

Various types of document repositories may be provided within the scope of the invention. For instance, the LIBAC system may include:

A global document repository 206 (accessible by all LIBAC customers) contains draft, generic financial documents and templates.

A corporate repository 208 contains all documents (from multiple projects) for a LIBAC customer. Each customer can store and retrieve their documents from this secure repository.

A project repository 210 contains drafts and versions of project documents. A document owner/project manager/team member can store and retrieve documents from this secure repository. Team members can also synchronize centrally and locally stored versions of the documents.

Document Conversion and Filing

Depending on the regulatory requirements of each LIBAC customer, customers can use the LIBAC technology to complete an on-line filing of Financial Documents directly to the SEC or other regulatory agencies. The LIBAC technology includes a conversion tool 212 that converts Financial Documents into the format required for on-line SEC filing.

Document Production

LIBAC has alliances with many regional and national printing companies that can accept (on-line) and produce Financial Documents. The LIBAC technology allows LIBAC customers to specify production needs for one or multiple printing companies. If the field is left blank, the system give lowest cost among all providers listed. The Document Production module 214 includes pricing information (based on quantity, location and timeline) for these printing companies. Printers in the LIBAC network use the Production module to update pricing lists and printing schedule information for each plant location.

A sample workflow for this module is as follows:

XYZ Corp wants to produce 500 document copies for New York City, 200 copies for San Francisco, and 50 copies for Denver.

XYZ uses Document Production to select printers in New York City, San Francisco, and Denver that meet their price and timeline requirements or the lowest cost site for printing all 750 sets of the document at one location from which shippers would deliver to the respective cities in the distribution list (whichever option the client chooses because sometimes price will be the driver and sometimes price is less of a concern and time of delivery is most critical).

XYZ uses Document Production to transmit a soft, print-ready copy of the document to the New York City, San Francisco, and Denver printers or one soft copy to the lowest cost plant is cost is the driver and timelines can still be met using 3^{rd} party shippers.

The printer(s) use Document Production to confirm the receipt and completion of the documents.

XYZ uses Document Distribution to specify and manage the distribution lists of the documents from the printer(s).

Document Distribution

The Document Distribution Module 216 contains the functionality that allows LIBAC customers to manage the distribution of Financial Documents. With Document Distribution, customers specify the quantity, destination, and shipping method for Financial Documents. This modules allows the drop shipping of documents directly from LIBAC alliance printing facilities and includes links to the tracking systems of common, national and international shippers (such as FedEx, UPS, or U.S. Mail).

User Interface

The LIBAC user interface 218 lets customers select from the above modules. Thereafter, the user interface lets customers select both process steps and documents. Additionally, the user interface lets each customer create a customized “skin” to personalize the interface.

At the LIBAC homepage, customers can purchase the LIBAC technology and services and set-up their accounts on a project by project basis. (note: all subscribing clients must purchase license agreements by speaking with sales representatives).

Application Interfaces

The LIBAC Printing and Distribution modules 220 include XML interfaces that LIBAC customers can use to interface these modules with their billing applications. The LIBAC User Interface, Filing, and Printing and Distribution modules include interfaces to LIBAC's credit card processing application so that customers can purchase the use of LIBAC technology and also make on-line payments for filing, printing and distribution requirements (which are 3^{rd} party alliances).

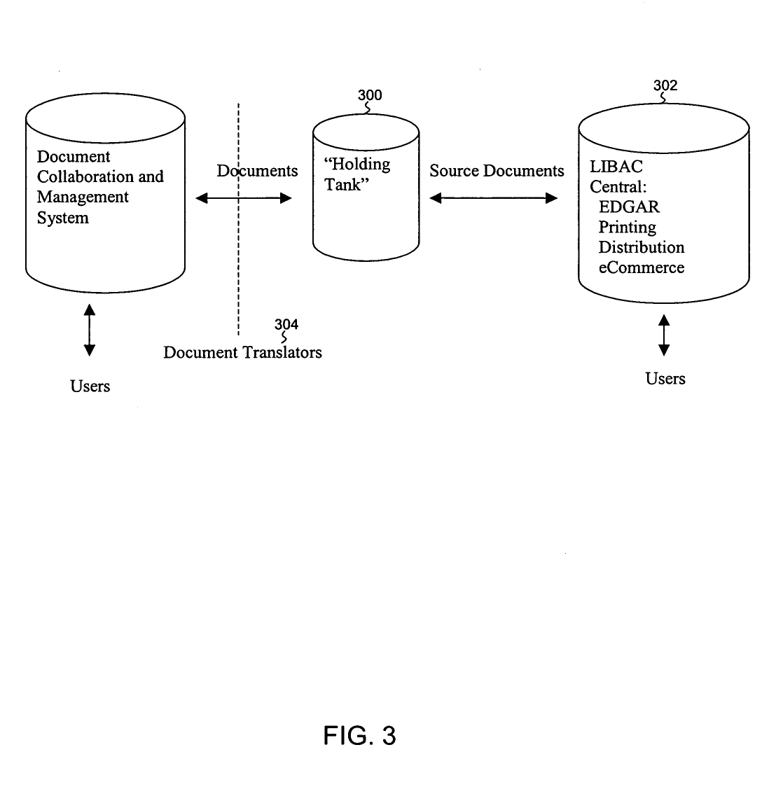

Referring to FIG. 3, in one configuration, LIBAC uses customized, existing technology for Document Collaboration and Management. In order to match the requirements for document merging, simultaneous viewing, and document element selection, document drafts are versioned and stored in a holding tank 300. Document owners view and edit documents in the holding tank. Upon approval, the application creates an updated source document. The source documents are maintained in the central LIBAC database. The EDGAR filing, printing, distribution, and eCommerce applications 302 run from the central database. Using document translators 304, the documents stored in the holding tank and in the central database are XML documents that can be viewed and revised using word processing applications.

While specific embodiments and applications of the present invention have been illustrated and described, it is to be understood that the invention is not limited to the precise configuration and components disclosed herein. Various modifications, changes, and variations apparent to those of skill in the art may be made in the arrangement, operation, and details of the methods and systems of the present invention disclosed herein without departing from the spirit and scope of the present invention.

What is claimed is:

1. A method for document project management comprising:
receiving a plurality of proposed revisions to an original portion of a document;
displaying the original portion of the document;
displaying with the original portion each of the plurality of proposed revisions;
highlighting differences with the original portion in each of the plurality of proposed revisions; and
allowing a reviewer to either select one of the proposed revisions or cut and paste text from one or more of the revisions to replace the original portion.

2. A document project management system comprising:
means for receiving a plurality of proposed revisions to an original portion of a document;
means for displaying the original portion of the document;
means for displaying with the original portion each of the plurality of proposed revisions;
means for highlighting differences with the original portion in each of the plurality of proposed revisions; and
means for allowing a reviewer to either select one of the proposed revisions or cut and paste text from one or more of the revisions to replace the original portion.
